(19) United States
(12) Patent Application Publication
(10) Pub. No.: US 2025/0130576 A1
(43) Pub. Date: Apr. 24, 2025

(54) DYNAMIC OCCUPANCY GRID ARCHITECTURE

(71) Applicant: QUALCOMM Incorporated, San Diego, CA (US)

(72) Inventors: Makesh Pravin JOHN WILSON, San Diego, CA (US); Avdhut JOSHI, San Marcos, CA (US); Radhika Dilip GOWAIKAR, San Diego, CA (US); Volodimir SLOBODYANYUK, San Diego, CA (US); Vishnuu APPAYA DHANABALAN, Munich (DE)

(21) Appl. No.: 18/827,951

(22) Filed: Sep. 9, 2024

Related U.S. Application Data
(60) Provisional application No. 63/592,596, filed on Oct. 24, 2023.

(51) Int. Cl. G05D 1/246; G05D 101/15; G05D 109/10; G05D 111/10; G05D 111/30; G05D 111/67; H04W 4/44

(52) U.S. Cl. CPC G05D 1/2464; H04W 4/44; G05D 2101/15; G05D 2109/10; G05D 2111/10; G05D 2111/32; G05D 2111/67

(57) ABSTRACT

Techniques are provided for utilizing a dynamic occupancy grid (DoG) for tracking objects proximate to an autonomous or semi-autonomous vehicle. An example method for generating an object track list in a vehicle includes obtaining sensor information from one or more sensors on the vehicle, determining a first set of object data based at least in part on the sensor information and an object recognition process, generating a dynamic grid based on an environment proximate to the vehicle based at least in part on the sensor information, determining a second set of object data based at least in part on the dynamic grid, and outputting the object track list based on a fusion of the first set of object data and the second set of object data.

### CROSS-REFERENCE TO RELATED APPLICATIONS

This application claims the benefit of U.S. Provisional Application No. 63/592,596, filed Oct. 24, 2023, entitled “DYNAMIC OCCUPANCY GRID ARCHITECTURE,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow.

A driver assistance system may mitigate driving risk for a driver of an ego vehicle (i.e., a vehicle configured to perceive the environment of the vehicle) and/or for other road users. Driver assistance systems may include one or more active devices and/or one or more passive devices that can be used to determine the environment of the ego vehicle and, for semi-autonomous vehicles, possibly to notify a driver of a situation that the driver may be able to address. The driver assistance system may be configured to control various aspects of driving safety and/or driver monitoring. For example, a driver assistance system may control a speed of the ego vehicle to maintain at least a desired separation (in distance or time) between the ego vehicle and another vehicle (e.g., as part of an active cruise control system). The driver assistance system may monitor the surroundings of the ego vehicle, e.g., to maintain situational awareness for the ego vehicle. The situational awareness may be used to notify the driver of issues, e.g., another vehicle being in a blind spot of the driver, another vehicle being on a collision path with the ego vehicle, etc. The situational awareness may include information about the ego vehicle (e.g., speed, location, heading) and/or other vehicles or objects (e.g., location, speed, heading, size, object type, etc.).

### SUMMARY

An example method for generating an object track list in a vehicle according to the disclosure includes obtaining sensor information from one or more sensors on the vehicle, determining a first set of object data based at least in part on the sensor information and an object recognition process, generating a dynamic grid based on an environment proximate to the vehicle based at least in part on the sensor information, determining a second set of object data based at least in part on the dynamic grid, and outputting the object track list based on a fusion of the first set of object data and the second set of object data.

An example apparatus according to the disclosure includes at least one memory, one or more sensors, at least one processor communicatively coupled to the at least one memory and the one or more sensors, and configured to: obtain sensor information from the one or more sensors, determine a first set of object data based at least in part on the sensor information and an object recognition process, generate a dynamic grid based at least in part on the sensor information, determine a second set of object data based at least in part on the dynamic grid, and output an object track list based on a fusion of the first set of object data and the second set of object data.

Items and/or techniques described herein may provide one or more of the following capabilities, as well as other capabilities not mentioned. An autonomous or semi-autonomous vehicle may include one or more sensors such as cameras, radar, and lidar. Low-level perception operations may be performed on the information obtained by the sensors. A dynamic occupancy grid may be generated based on the input received from the sensors. Clusters of dynamic cells in the dynamic occupancy grid may be identified. The results of the low-level perception operations and the identified dynamic cell clusters may be fused to generate object track lists. The dynamic occupancy grid may be configured to generate static object lists. The object track lists and the static object lists may be provided to perception planning modules in the vehicle. The fusion of low-level perception object detection results with dynamic grid detection techniques may enable the detection of smaller objects, or other objects which are outside of the training of machine learning models utilized in the low-level perception operations. The bandwidth and/or complexity required to provide dynamic and static object information to perception planning modules may be reduced. Other capabilities may be provided and not every implementation according to the disclosure must provide any, let alone all, of the capabilities discussed.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is a block diagram of an example method of dynamic grid clustering.

FIG. 10 is a block diagram of an example functional architecture of an environment modeling block of the device shown in FIG. 5.

FIG. 11 is a block diagram of an example process for controlling an autonomous vehicle.

FIG. 12 is a block diagram of an example functional architecture of an environment modeling block with occlusion grid computation.

FIG. 13 is a block diagram of an example functional architecture of an environment modeling block including external constraints.

FIG. 14 is a process flow diagram of an example method for generating an object track list in a vehicle.

FIG. 15 is a process flow diagram of an example method for generating a motion plan for an autonomous vehicle.

### DETAILED DESCRIPTION

Techniques are discussed herein for utilizing a dynamic occupancy grid (DoG) for tracking objects proximate to an autonomous or semi-autonomous vehicle. For example, measurements from multiple sensors, including one or more radars and a camera, may be obtained and measurements therefrom may be used in object recognition processes and to determine a dynamic grid. The object recognition processes may be part of a low level perception (LLP) module and may be based on machine learning models. The dynamic grid may include a clustering process configured to detect dynamic objects. Objects detected by the LLP may be fused with the dynamic objects detected via the dynamic grid to generate an object tracking list. Static obstacles may also be detected via the dynamic grid. The object tracking list and static obstacle information may be provided to perception and planning modules in the vehicle. In an example, the dynamic grid may be configured to identify occluded cells within the grid. The detection of dynamic objects may be assisted with the use of map data and remote sensor information. In an example, the dynamic grid may utilize vehicle-to-everything (V2X) signaling to improve the detection of dynamic objects. Other techniques, however, may be used.

Particular aspects of the subject matter described in this disclosure may be implemented to realize one or more of the following potential advantages. The fusion of LLP object detection results with dynamic grid detection techniques may enable the detection of smaller objects, or other objects which are outside of the training of the LLP. The bandwidth and/or complexity required to provide dynamic and static object information to perception planning modules may be reduced. Object tracking information may be compressed and/or simplified. Object detection machine learning models may be trained based on dynamic grid object detection results. Object classification may be based on a fusion of LLP object detection and dynamic grid clustering results. Static obstacles may also be classified. Remote sensors from other vehicles may utilize V2X signaling to improve dynamic grid detection results. Other advantages may also be realized.

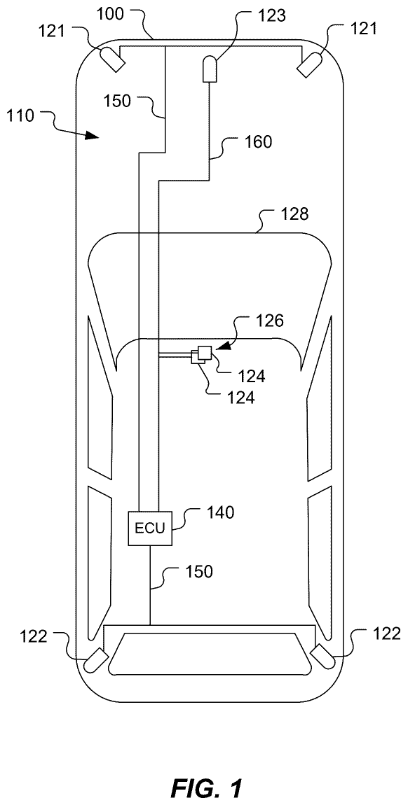

Referring to FIG. 1, an ego vehicle 100 includes an ego vehicle driver assistance system 110. The driver assistance system 110 may include a number of different types of sensors mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle 100, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121, 122 may include an LRR and/or an SRR (Short-Range Radar). The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

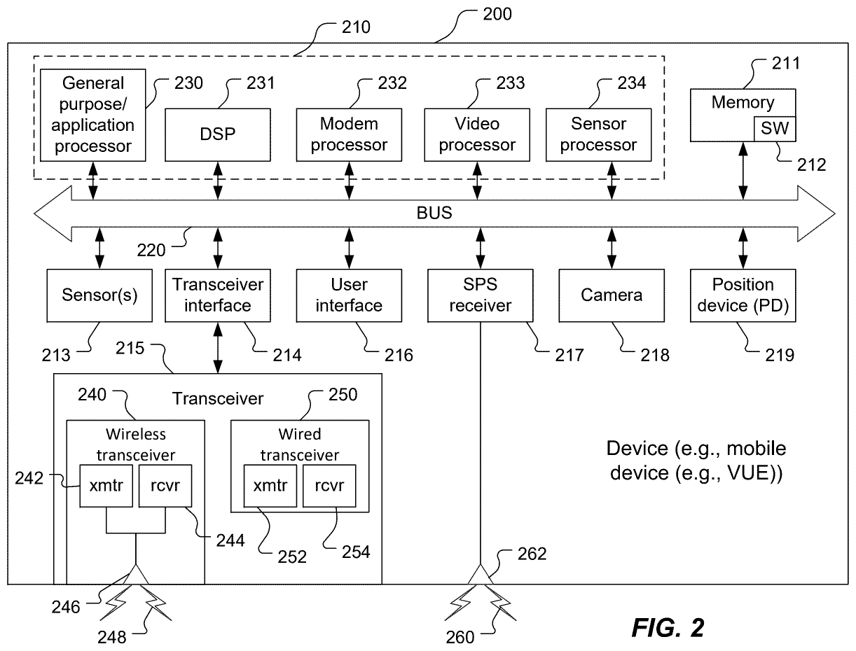

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The terms “user equipment” or “UE” (or variations thereof) are not specific to or otherwise limited to any particular Radio Access Technology (RAT), unless otherwise noted. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of another object (e.g., another device) with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a coverage area of a serving base station and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

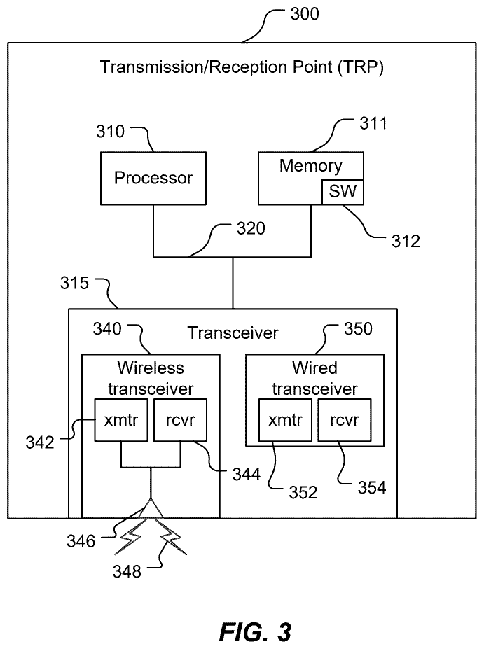

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. Even if referred to in the singular, the processor 310 may include one or more processors, the transceiver 315 may include one or more transceivers (e.g., one or more transmitters and/or one or more receivers), and/or the memory 311 may include one or more memories. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

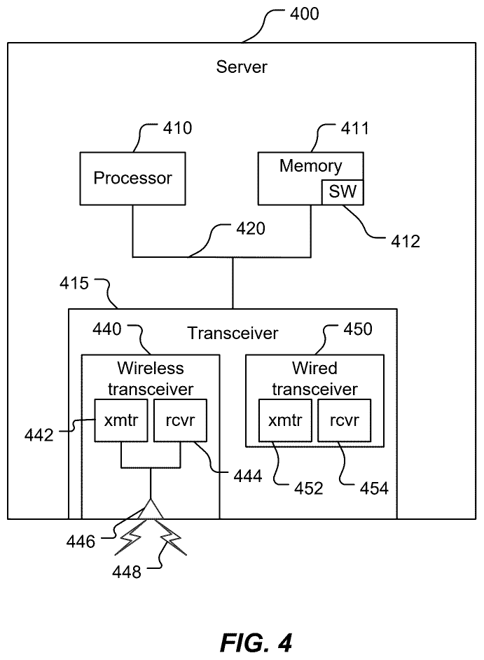

Referring also to FIG. 4, a server 400, of which an LMF is an example, may comprise a computing platform including a processor 410, memory 411 including software (SW) 412, and a transceiver 415. Even if referred to in the singular, the processor 410 may include one or more processors, the transceiver 415 may include one or more transceivers (e.g., one or more transmitters and/or one or more receivers), and/or the memory 411 may include one or more memories. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

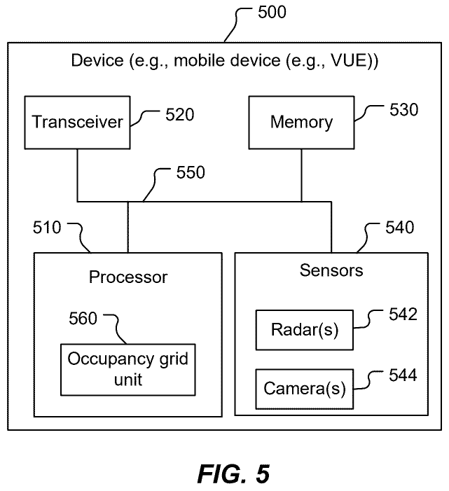

Referring to FIG. 5, a device 500 includes a processor 510, a transceiver 520, a memory 530, and sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. The sensors 540 include one or more radar sensors 542 and one or more cameras 544. The sensors 540 may include other sensors, such as lidar, Hall-effect sensors, ultrasound sensors, or other sensors configured to assist vehicle operations.

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy grid unit 560 (which may include an ADAS (Advanced Driver Assistance System) for a VUE). The occupancy grid unit 560 is discussed further herein, and the description herein may refer to the occupancy grid unit 560 performing one or more functions, and/or may refer to the processor 510 generally, or the device 500 generally, as performing any of the functions of the occupancy grid unit 560, with the device 500 being configured to perform the functions.

One or more functions performed by the device 500 (e.g., the occupancy grid unit 560) may be performed by another entity. For example, sensor measurements (e.g., radar measurements, camera measurements (e.g., pixels, images)) and/or processed sensor measurements (e.g., a camera image converted to a bird's-eye-view image) may be provided to another entity, e.g., the server 400, and the other entity may perform one or more functions discussed herein with respect to the occupancy grid unit 560 (e.g., using machine learning to determine a present occupancy grid and/or applying an observation model, analyzing measurements from different sensors, to determine a present occupancy grid, etc.).

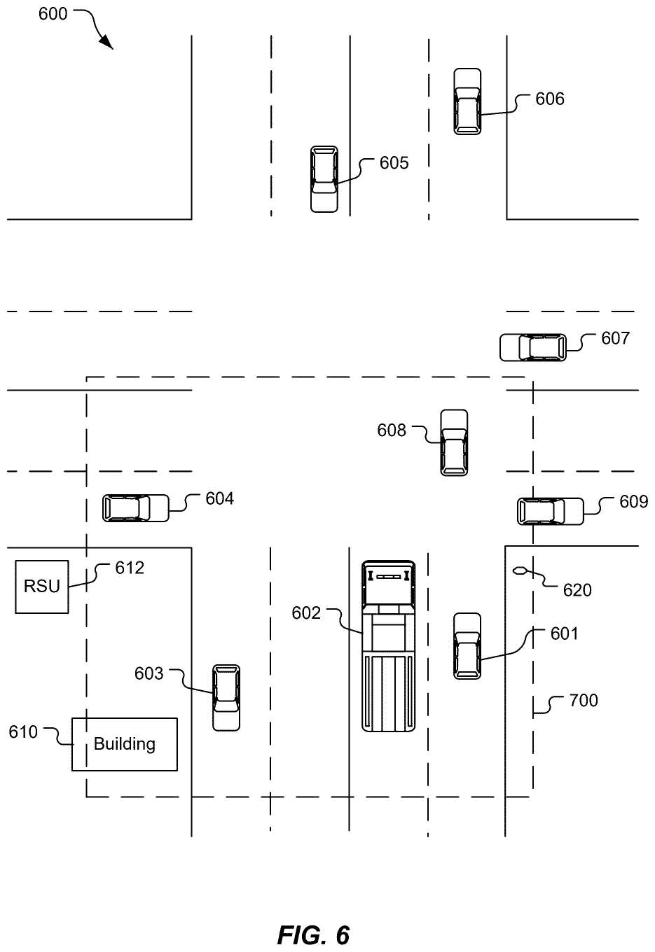

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type or class (bicycle, car, truck, etc.), etc.).

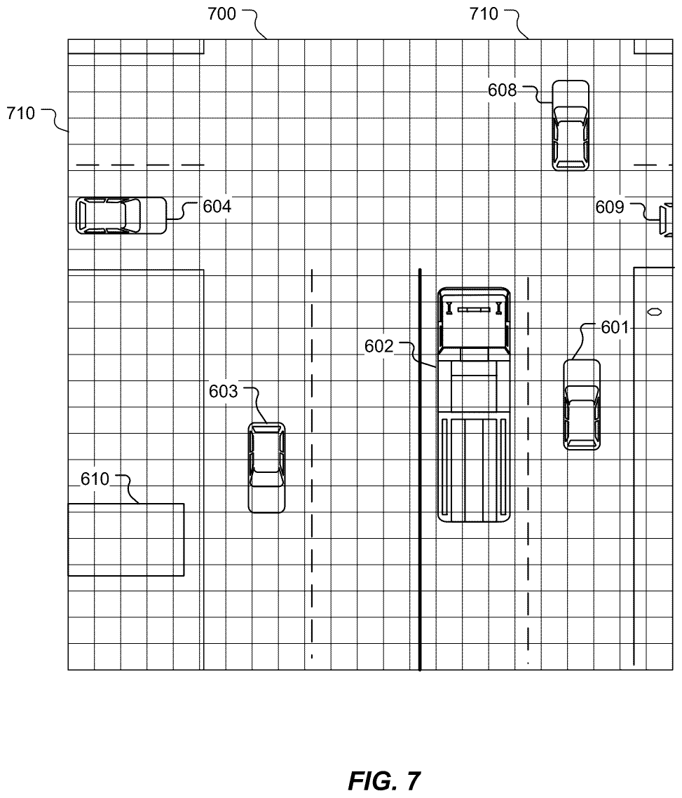

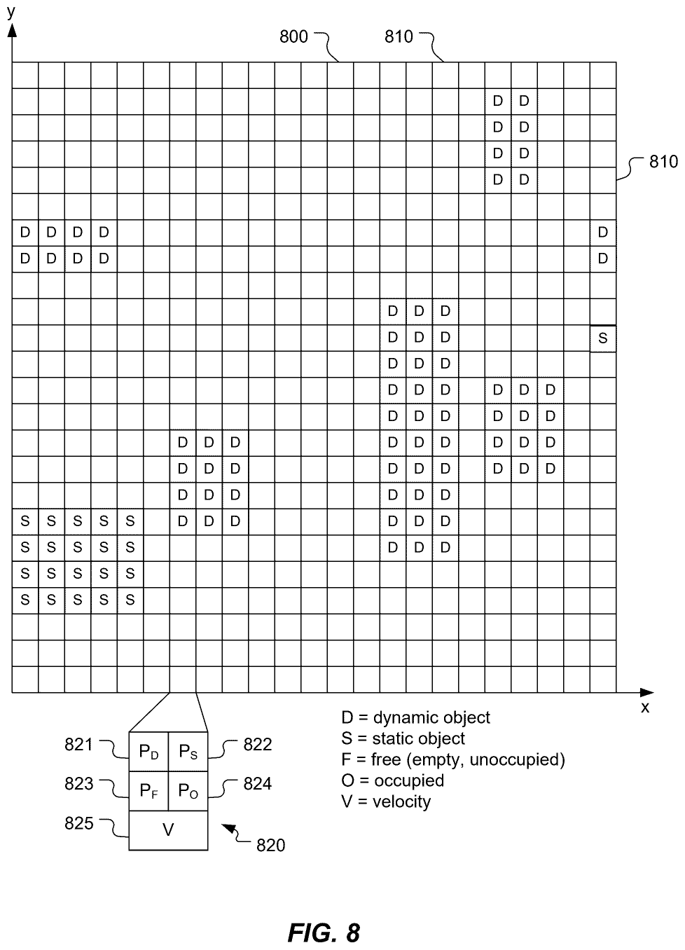

Referring also to FIGS. 7 and 8, a region 700, which in this example spans a portion of the environment 600, may be evaluated to determine an occupancy grid 800 (also called an occupancy map) that indicates multiple probabilities for each cell of the grid 800 whether the cell is occupied or free, and whether an occupying object is static or dynamic. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub-regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8). As another example, a grid may comprise a 512×512 array of sub-regions. Still other implementations of occupancy grids may be used.

Each of the sub-regions 710 may correspond to a respective cell 810 of the occupancy map and information may be obtained regarding what, if anything, occupies each of the sub-regions 710 and whether an occupying object is static or dynamic in order to populate cells 810 of the occupancy grid 800 with probabilities of the cell being occupied (O) or free (F) (i.e., unoccupied), and probabilities of an object at least partially occupying a cell being static (S) or dynamic (D). Each of the probabilities may be a floating point value. The information as to what, if anything, occupies each of the sub-regions 710 may be obtained from a variety of sources. For example, occupancy information may be obtained from sensor measurements from the sensors 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include a set 820 of occupancy information indicating a dynamic probability 821 (P_{D}), a static probability 822 (P_{S}), a free probability 823 (P_{F}), an occupied probability 824 (P_{P}), and a velocity 825 (V). The dynamic probability 821 indicates a probability that an object (if any) in the corresponding sub-region 710 is dynamic. The static probability 822 indicates a probability that an object (if any) in the corresponding sub-region 710 is static. The free probability 823 indicates a probability that there is no object in the corresponding sub-region 710. The occupied probability 824 indicates a probability that there is an object in (any portion of) the corresponding sub-region 710. Each of the cells 810 may include respective probabilities 821-824 of an object corresponding to the cell 810 being dynamic, static, absent, or present, with a sum of the probabilities being 1. In the example shown in FIG. 8, cells more likely to be free (empty) than occupied are not labeled in the occupancy grid 800 for sake of simplicity of the figure and readability of the occupancy grid 800. Also as shown in FIG. 8, cells more likely to be occupied than free, and occupied by an object that is more likely to be dynamic than static are labeled with a “D”, and cells more likely to be occupied than free, and occupied by an object that is more likely to be static than dynamic are labeled with a “S”. An ego vehicle may not be able to determine whether a cell is occupied or not (e.g., being behind a visible surface of an object and not discernable based on an observed object (e.g., if the size and shape of a detected object is unknown)), and such a cell may be labeled as unknown occupancy.

Building a dynamic occupancy grid (an occupancy grid with a dynamic occupier type) may be helpful, or even essential, for understanding an environment (e.g., the environment 600) of an apparatus to facilitate or even enable further processing. For example, a dynamic occupancy grid may be helpful for predicting occupancy, for motion planning, etc. A dynamic occupancy grid may, at any one time, comprise one or more cells of static occupier type and/or one or more cells of dynamic occupier type. A dynamic object may be represented as a set of one or more velocity vectors. For example, an occupancy grid cell may have some or all of the occupancy probability be dynamic, and within the dynamic occupancy probability, there may be multiple (e.g., four) velocity vectors each with a corresponding probability that together sum to the dynamic occupancy probability for that cell 810. A dynamic occupancy grid may be obtained, e.g., by the occupancy grid unit 560, by processing information from multiple sensors, e.g., of the sensors 540, such as from a radar system. Adding data from one or more cameras to determine the dynamic occupancy grid may provide significant improvements to the grid, e.g., accuracy of probabilities and/or velocities in grid cells.

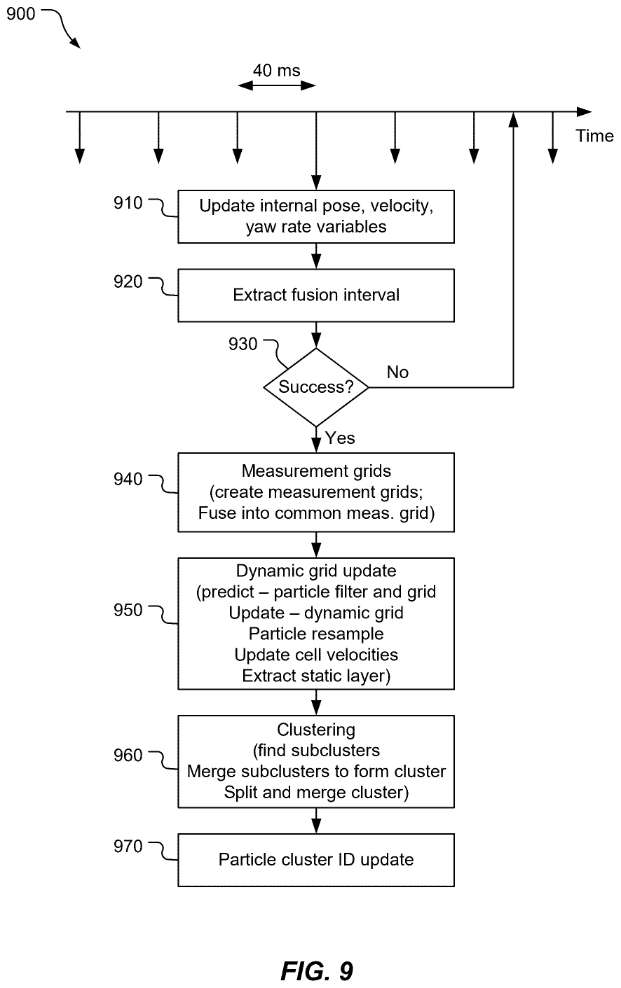

Referring also to FIG. 9, a method 900 of dynamic grid clustering includes the stages shown. The method 900 is, however, an example and not limiting. The method 900 may be altered, e.g., by having one or more stages added, removed, rearranged, combined, performed concurrently, and/or having one or more stages each split into multiple stages. At stage 910, intermittent interrupts 901 (e.g., at a periodic interval 905, e.g., every 40 ms in this example) occurs and a check is made by the processor 510 to determine whether sensor data are available (e.g., vehicle localization information such as speed). In this example, a check is made corresponding to an intermittent interrupt 906. If sensor data are available, then internal pose, velocity, and yaw rate variables are updated based on the sensor data. At stage 920, an extract fusion interval function is performed where sensor data are collected over time. At stage 930, the processor 510 determines whether one or more rules are met corresponding to success, such as at least a threshold number of radar measurements having been made over a specified time interval. If there is success (the rule(s) have been met), then the method 900 proceeds to stage 940, and otherwise returns to checking for data for updating at stage 910. At stage 940, a measurement grid is determined for each sensor for which sensor data are available. Values for grid points for each sensor (e.g., radar, camera, etc.) may be determined. For example, an M×N array (e.g., a 512×512 array) for each sensor may be determined and the arrays combined into a single M×N array of grid points. At stage 950, a dynamic grid update is performed. The processor 510 may determine a predicted grid (e.g., using a particle filter), and may fuse the measurement grid from stage 940 with the predicted grid. At stage 960, a clustering function is performed, e.g., with the processor 510 determining and grouping grid cells with similar velocities and positions (i.e., cells close to each other with similar velocities). At stage 970, a particle cluster ID update function is performed to track the cluster ID (from stage 960) within the particle.

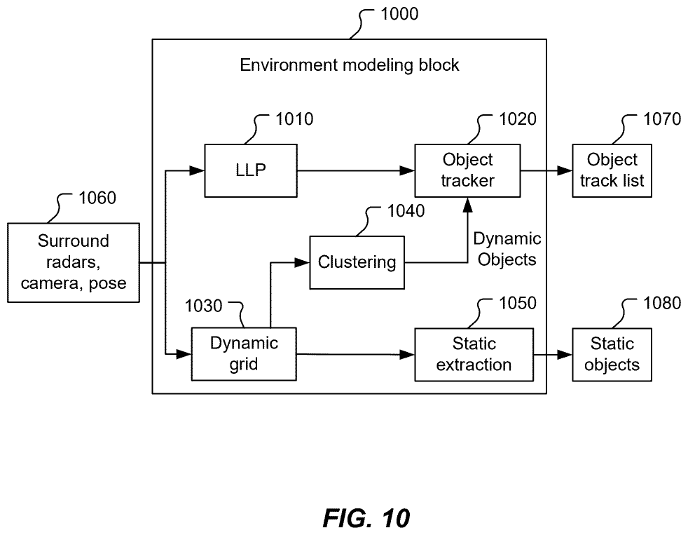

Referring also to FIG. 10, a functional architecture of an environment modeling block 1000 of the device 500 includes functional blocks including an LLP 1010 (Low-Level Perception functional block), an object tracker functional block 1020, a dynamic grid functional block 1030, a clustering functional block 1040, and a static extraction functional block 1050. The LLP 1010 and the dynamic grid functional block 1030 may receive input data 1060 from the radar(s) 542 of the sensors 540, the camera(s) 544 of the sensors 540, and a pose of the device 500 (e.g., an orientation (e.g., yaw) of an ego vehicle relative to a reference axis). The LLP 1010 may be configured to apply machine learning to at least some of the input data 1060 to identify dynamic objects (e.g., vehicles) corresponding to the environment of the device 500, e.g., the environment 600, and output indications of identified objects to the object tracker 1020. The dynamic grid functional block 1030 may be configured to use at least some of the input data 1060 to determine a dynamic grid, e.g., including occupancy probabilities, static/dynamic probabilities, and velocities. The dynamic grid determined by the dynamic grid functional block 1030 may be smaller than a dynamic grid determined by the LLP 1010. The dynamic grid functional block 1030 may use more traditional (non-machine-learning) techniques, which may identify some objects that the LLP 1010 does not identify (e.g., objects with odd shapes and/or disposed at odd angles relative to the device 500). In an example, the dynamic grid functional block 1030 may utilize machine learning labels (e.g., outputs) to generate class information associated with detected objects (e.g., car, truck, road edge, etc.). The dynamic grid functional block 1030 may provide the dynamic grid to the clustering functional block 1040 and to the static extraction functional block 1050. The clustering functional block 1040 may be configured to identify clusters of dynamic grid cells with similar properties, e.g., similar object classifications and/or similar velocities, and provide indications of clusters of grid cells of dynamic objects to the object tracker 1020. In an example, the clustering may be based at least in part on class information. The class information may also be utilized by the static extraction functional block 1050 to provide segmentation output in addition to static object information. The object tracker 1020 may be configured to use the indications of identified objects from the LLP 1010 and indications of clusters of dynamic grid cells from the clustering functional block 1040 to track objects, e.g., using a Kalman Filter (and/or other algorithm(s)). The object tracker 1020 may be configured to fuse the identified objects from the LLP 1010 with dynamic objects (corresponding to cell clusters) determined by the clustering functional block 1040, and output an object track list 1070 indicating tracked objects. The object track list 1070 may include a location, velocity, length, and width (and possibly other information) for each object in the object track list 1070. The object track list 1070 may include a shape to represent each object, e.g., a closed polygon or other shape (e.g., an oval (e.g., indicated by values for the major and minor axes)), with different objects being represented by the same shape or different shapes. The static extraction functional block 1050 may be configured to determine static objects (e.g., road boundaries, traffic signs, etc.) in the dynamic grid provided by the dynamic grid functional block 1030, and provide a static object list 1080 indicating the determined static objects.

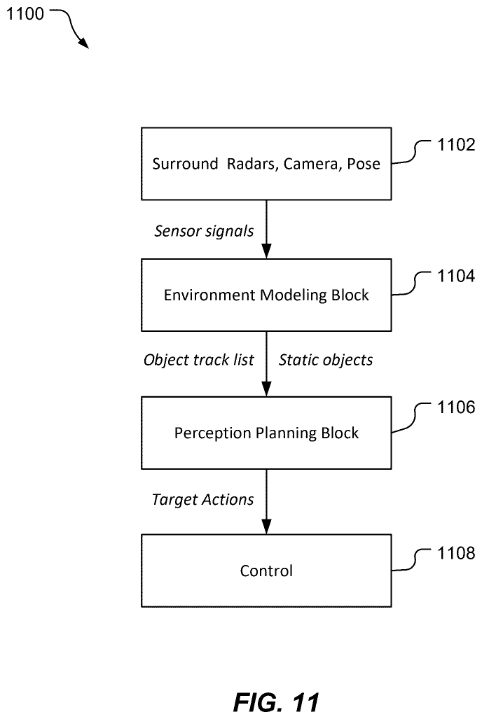

Referring to FIG. 11, an example process 1100 for controlling an autonomous vehicle is shown. The process 1100 is, however, an example and not limiting. The process 1100 may be altered, e.g., by having one or more stages added, removed, rearranged, combined, performed concurrently, and/or having one or more stages each split into multiple stages.

At stage 1102, the process includes obtaining input from one or more sensors. The sensors may include the radar(s) 542 of the sensors 540, the camera(s) 544 of the sensors 540, and the input may include a pose of the device 500 (e.g., an orientation (e.g., yaw) of an ego vehicle relative to a reference axis). The signals obtained by the sensors may be provided to a perception module, such as the environment modeling block 1000 described in FIG. 10.

At stage 1104, the process includes processing the sensor input with the environment modeling block 1000. In general, the environment modeling block is configured to determine a contextual understanding of an environment, such as detecting and classifying proximate vehicles or objects (e.g., cars, trucks, bicycles, pedestrians, etc.), determining the location of proximate obstacles, detecting road signs, and categorizing data based on semantic definitions. The environment modeling block 1000 may be configured to analyze the sensor data with one or more object recognition processes. For example, the LLP 1010 may be configured to utilize one or more machine learning models to identify objects detected by the sensors 540. The LLP 1010 may be configured to perform a per frame analysis for the sensor data and provide indications (e.g., output labels) from machine learning models to the object tracker 1020. In an example, the output labels may be parametric values (e.g., position coordinates, vehicles, sizes, lanes, etc.). The object tracker 1020 is configured to track the indications (e.g., objects) over time and output the object track list 1070. The dynamic grid functional block 1030 and the clustering functional block 1040 may be configured to provide non-parametric object information (e.g., sets 820 of occupancy information) associated with dynamic objects to the object tracker 1020. The object tracker 1020 may be configured to perform a fusion of the LLP objects (e.g., parameterized objects) and the clustered objects (e.g., non-parametric objects) to output the object track list 1070, including, for example, shapes to represent the objects, e.g., closed polygons or other shapes. The static extraction functional block 1050 may be configured to determine static objects (e.g., road boundaries, traffic signs, etc.) in the dynamic grid provided by the dynamic grid functional block 1030, and provide the static objects 1080 indicating the determined static objects. The object track list 1070 and the static objects 1080 may be provided to other perception modules utilizing lower bandwidth and less complicated interfaces as compared to providing the dynamic grid information and LLP objects directly.

At stage 1106, the process includes providing the object track list 1070 and the static objects 1080 from the environment modeling block 1000 to a perception planning block. In an example, the perception planning block may be configured to perform mission, behavioral, and/or motion planning functions. The mission planning functions may include an analysis of traversable road segments based on map information. The behavioral planning may include operating the vehicle in compliance with local rules of the road. The motion planning functions may include generating paths of motion to avoid collisions with obstacles, such as provided in the object track list 1070 and the static objects 1080. Other decision-making structures for obstacle avoidance may also utilize the object track list 1070 and the static objects 1080. The perception planning block may be configured to output one or more target actions to one or more control modules.

At stage 1108, the process includes providing target actions to control modules. The control modules are configured to execute the target actions provided by the perception planning block. For example, the control modules may be configured to provide commands to actuators such as steering, acceleration and braking to control the motion of the vehicle. The controllers may also be configured to perform trajectory and path tracking and provide feedback to one or more perception planning blocks.

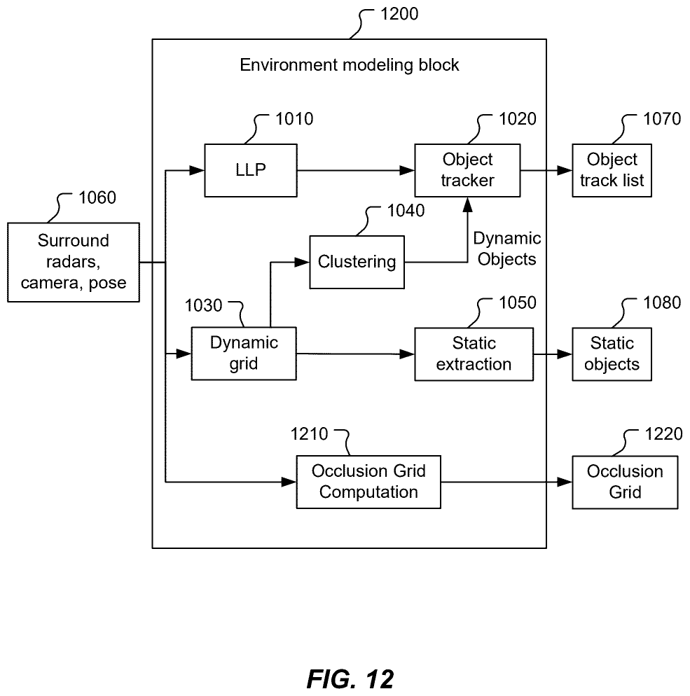

Referring to FIG. 12, with further reference to FIGS. 6 and 10, an example functional architecture of an environment modeling block 1200 with an occlusion grid computation 1210 is shown. In general, the occlusion grid computation 1210 is configured to receive the input data 1060 from the radar(s) 542 of the sensors 540, the camera(s) 544 of the sensors 540, and determine if a sub-region 710 in a dynamic grid has an occluded status (e.g., if the cell is not visible by the ego vehicle, e.g., being obscured by another object (e.g., cells in a field of view of the vehicle 601 obscured by the vehicle 602)) and output an occlusion grid 1220. In an example, the dynamic grid functional block 1030 may be configured to utilize the Dempster Shafer theory of evidence to determine if a cell has an occluded status. For example, referring to FIG. 8, the occupancy information may indicate an occluded status (e.g., Pox) if a sub-region 710 was previously in view and is now blocked from view. The occupancy information may indicate multiple occupier types, e.g., mobile occluded if the sub-region 710 was previously determined to be occupied by a mobile object but the sub-region 710 is now occluded. In the example occupancy grid 800, the vehicle 601 shown in FIG. 6 is the ego vehicle, and occupancy information for all of the cells 810 has been able to be determined. In the occupancy grid 800, the cells 810 that are not labeled (for sake of clarity of the figure) may be free space, unknown, or occluded. In an example, prediction, update and/or conflict rules within the dynamic grid functional block 1030 may be specified based at least in part on the occlusion grid 1220.

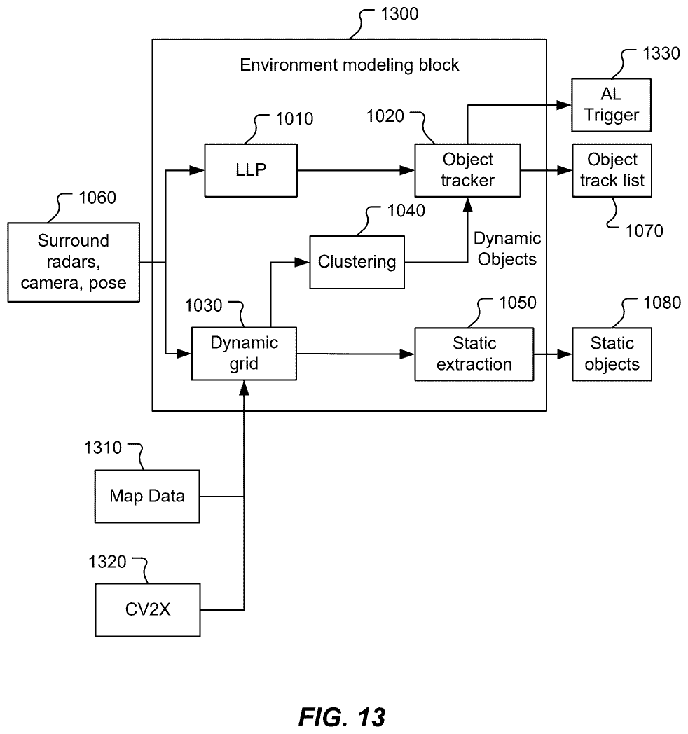

Referring to FIG. 13, with further reference to FIG. 10, a block diagram of an example functional architecture of an environment modeling block 1300 including external constraints is shown. The environment modeling block 1300 includes a map data module 1310 and a CV2X module 1320 that are communicatively coupled to the dynamic grid functional block 1030. In an example, the map data module 1310 may be a navigation system operating on the device 500 and/or the device 200. The dynamic grid functional block 1030 may be configured to receive map information to enhance the determination of dynamic grid cells. For example, when a car is traveling in the far left lane of a three lane road and becomes occluded to a car traveling in the right lane by a truck traveling in the center lane, the map information may provide an indication of whether the road is straight or curved, or whether there is an intersection. The map data may be used to enhance the probabilities of the cells associated with the occluded vehicle (e.g., the dynamic grid cells). Knowledge of the map information may be used to provide an initial probability for the grid computation. For example, rather than initializing a solution with all grid cells having an unknown status, the dynamic grid functional block 1030 may be configured to utilize the map information to initialize with static masses for the grid cells (e.g., wherever there is no road), and a free/dynamic mass for wherever there is road. Further output of dynamic grid functional block 1030 may be fused with the map information to enhance the accuracy of the resulting dynamic grid.

The CV2X module 1320 may be configured to provide map information and/or additional sensor information to the dynamic grid functional block 1030. For example, other wireless nodes such as UEs, vehicles, RSUs, and base stations (e.g., gNB) may be configured to provide their respective sensor readings to the device 500. In an example, the other wireless nodes may provide their representations of dynamic grids for an area. The additional grid representations may be utilized by the dynamic grid functional block 1030 to improve the accuracy of the dynamic grid. The additional dynamic grid information received from outside sources (e.g., the other wireless nodes) may be used to improve tracking of occluded cells. The locations of the other wireless nodes (e.g., other vehicles) may also be utilized to improve the estimates of dynamic objects in the grid by association of dynamic grid masses with the locations of the other vehicles. An RSU may be configured to provide traffic light and traffic state information via a V2X link (e.g., Uu, PC5) which may enhance the dynamic grid determination. For example, geographic knowledge of the intersection and an indication that a traffic light is red may increase the probability that detected objects are stopped vehicles. Other associations based on the state of traffic at an intersection may be used.

In an example, the fusion of the dynamic objects and the indications of identified objects from the LLP 1010 in the object tracker 1020 may generate object results which were not identified by the LLP 1010. That is, the clusters identified by the clustering functional block 1040 may correspond to objects which were not in the training data for the machine learning models in the LLP 1010. The object tracker 1020 may be configured to output an Active Learning (AL) trigger 1330 to update the training in the LLP 1010 based on the objects identified in the dynamic grid. In an example, the object tracker 1020 may be configured to compare the cluster list (e.g., the clusters identified by the clustering functional block 1040) and objects from LLP 1010, and determine if that particular frame or frames (e.g., data from radar/camera/sensors in a time instant or over a window of time around the time instant (e.g., 0.5, 1.0, 1.5 secs etc.)) may be selected for further training. The selected frames may be stored in a storage device for offline training or fed for online training. The determination of the frame may be based on comparing the differences between the two outputs. Frames with higher differences (e.g., above a threshold value) may be selected by the AL trigger 1330. In general, the selection algorithm may be based on comparing directly the LLP 1010 and the dynamic grid 1030 outputs. For example, if the AL trigger 1330 indicates the scene to be more of an intersection type (e.g., based on the static mass layout), this classification may be an aspect for selecting the corresponding frames for further training.

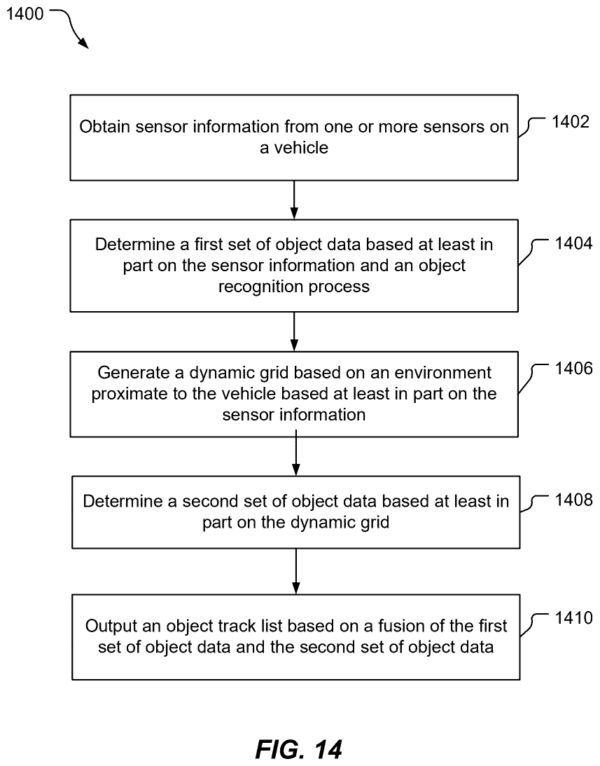

Referring to FIG. 14, with further reference to FIGS. 1-13, a method 1400 for generating an object track list in a vehicle includes the stages shown. The method 1400 is, however, an example and not limiting. The method 1400 may be altered, e.g., by having one or more stages added, removed, rearranged, combined, performed concurrently, and/or having one or more stages each split into multiple stages.

At stage 1402, the method includes obtaining sensor information from one or more sensors on a vehicle. The device 500, including the processor 510 and the sensors 540, are a means for obtaining the sensor information. In an example, referring to FIG. 10, the environment modeling block 1000 may be configured to obtain the sensor information. The LLP 1010 and the dynamic grid 1030 functional blocks may receive input data 1060 from the radar(s) 542 of the sensors 540, the camera(s) 544 of the sensors 540, and a pose of the device 500 (e.g., an orientation (e.g., yaw) of an ego vehicle relative to a reference axis).

At stage 1404, the method includes determining a first set of object data based at least in part on the sensor information and an object recognition process. The device 500, including the processor 510 and the environment modeling block 1000, are a means for determining the first set of object data. In an example, the LLP 1010 may be configured to implement an object recognition process via one or more machine learning models configured to receive at least some of the input data 1060 to identify dynamic objects (e.g., vehicles) corresponding to the environment of the device 500 (e.g., the environment 600). The machine learning models may be based on deep learning techniques such as, for example camera deep learning (DL) detection models, low-level (LL) fusion of objects models, and radar detections models. The machine learning models may be trained to output the object data based on the inputs received from the sensors 540.

At stage 1406, the method includes generating a dynamic grid based on an environment proximate to the vehicle based at least in part on the sensor information. The device 500, including the processor 510 and the environment modeling block 1000, are a means for generating the dynamic grid. The dynamic grid functional block 1030 may be configured to use at least some of the input data 1060 to determine the dynamic grid including occupancy probabilities, static/dynamic probabilities, and velocities. In an example, the dynamic grid functional block 1030 may use more traditional (non-machine-learning) techniques, which may identify some objects that the LLP 1010 does not identify (e.g., objects with odd shapes and/or disposed at odd angles relative to the device 500). In an example, the dynamic grid functional block 1030 may utilize machine learning labels (e.g., outputs) to generate class information associated with detected objects (e.g., car, truck, road edge, etc.). For example, the dynamic grid functional block 1030 may include one or more machine learning models such as a camera drivable space model, a camera based semantic segmentation (Camera SemSeg) model, a radar point cloud model, and a low-level birds eye view (BEV) segmentation and occupancy flow model. Other models may also be used to generate the dynamic grid.

At stage 1408, the method includes determining a second set of object data based at least in part on the dynamic grid. The device 500, including the processor 510 and the environment modeling block 1000, are a means for determining the second set of object data. In an example, the dynamic grid functional block 1030 may provide the dynamic grid to the clustering functional block 1040 and to the static extraction functional block 1050. The clustering functional block 1040 may be configured to generate the second set of object data based on identifying clusters of dynamic grid cells with similar properties, e.g., similar object classifications and/or similar velocities. In an example, the clustering may be based at least in part on class information. In an example, the static extraction functional block 1050 may be configured to generate a third set of object data based on the static objects (e.g., road boundaries, traffic signs, etc.) in the dynamic grid information provided by the dynamic grid functional block 1030.

At stage 1410, the method includes outputting an object track list based on a fusion of the first set of object data and the second set of object data. The device 500, including the processor 510 and the environment modeling block 1000, are a means for outputting the object track list. In an example, the object tracker 1020 may be configured to use the first set of object data (e.g., indications of identified objects from the LLP 1010) and the second set of object data (e.g., indications of clusters of dynamic grid cells from the clustering functional block 1040) to track objects, e.g., using a Kalman Filter (and/or other algorithm(s)). The object tracker 1020 may be configured to fuse the identified objects from the LLP 1010 with dynamic objects (corresponding to cell clusters) determined by the clustering functional block 1040, and output the object track list 1070 indicating tracked objects. In an example, the object track list 1070 may include a location, velocity, length, and width (and possibly other information) for each object in the object track list 1070. The object track list 1070 may include a shape to represent each object, e.g., a closed polygon or other shape (e.g., an oval (e.g., indicated by values for the major and minor axes)).

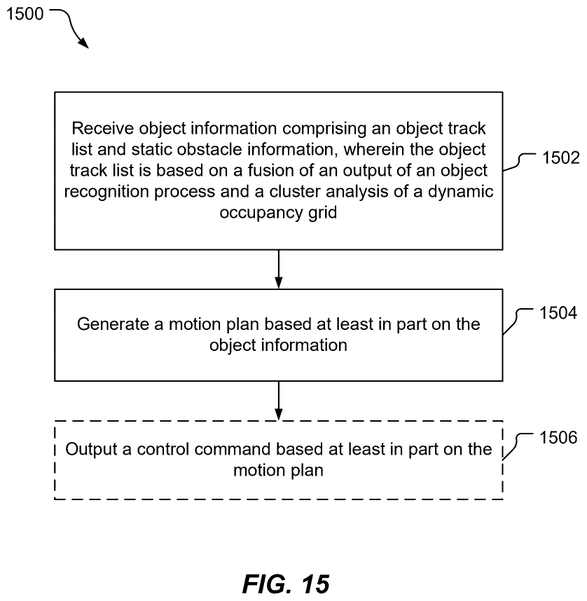

Referring to FIG. 15, with further reference to FIGS. 1-13, a method 1500 for generating a motion plan for an autonomous vehicle includes the stages shown. The method 1500 is, however, an example and not limiting. The method 1500 may be altered, e.g., by having one or more stages added, removed, rearranged, combined, performed concurrently, and/or having one or more stages each split into multiple stages. For example, outputting a control command at stage 1506 is optional.

At stage 1502, the method includes receiving object information comprising an object track list and static obstacle information, wherein the object track list is based on a fusion of an output of an object recognition process and a cluster analysis of a dynamic occupancy grid. The device 500, including the processor 510 and the perception planning block, is a means for receiving object information. In an example, the perception planning block may receive the object track list 1070 and the static objects 1080 from an environment modeling block 1000. The object track list represents a simplification of a dynamic grid in that the objects are provided in a list form, rather than the more complex raw output from the dynamic grid functional block 1030. The reduction in complexity and relative compression of the object data may also reduce the bandwidth required to provide object information to perception planning blocks and/or other planning control elements.

At stage 1504, the method includes generating a motion plan based at least in part on the object information. The device 500, including the processor 510 and the perception planning block, is a means for generating a motion plan. The perception planning block may be configured to perform mission, behavioral, and/or motion planning functions. The motion planning functions may include generating paths of motion to avoid collisions with obstacles, such as provided in the object track list 1070 and the static objects 1080. Other decision making structures for obstacle avoidance may also utilize the object track list 1070 and the static objects 1080.

At stage 1506, the method optionally includes outputting a control command based at least in part on the motion plan. The device 500, including the processor 510 and the perception planning block, is a means for outputting a control command. The perception planning block may be configured to output one or more target actions to one or more control modules. In an example, the control modules may be configured to receive control commands and provide commands to actuators such as steering, acceleration and braking to control the motion of the vehicle based on the control commands.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:
Clause 1. A method for generating an object track list in a vehicle, comprising: obtaining sensor information from one or more sensors on the vehicle; determining a first set of object data based at least in part on the sensor information and an object recognition process; generating a dynamic grid based on an environment proximate to the vehicle based at least in part on the sensor information; determining a second set of object data based at least in part on the dynamic grid; and outputting the object track list based on a fusion of the first set of object data and the second set of object data.
Clause 2. The method of clause 1 wherein the one or more sensors include at least a camera and a radar sensor.
Clause 3. The method of clause 1 wherein determining the second set of object data includes identifying clusters of dynamic grid cells in the dynamic grid.
Clause 4. The method of clause 3 wherein the clusters of dynamic grid cells have similar velocities.
Clause 5. The method of clause 3 wherein the clusters of dynamic grid cells have similar object classifications.
Clause 6. The method of clause 1 further comprising generating an occlusion grid comprising occluded grid cells, wherein determining the second set of object data is based at least in part on the occlusion grid.
Clause 7. The method of clause 1 wherein the object recognition process includes one or more machine learning models configured to output indications of identified objects based at least in part on the sensor information.
Clause 8. The method of clause 7 further comprising outputting an Active Learning (AL) trigger based at least in part on a comparison of the first set of object data and the second set of object data, wherein the AL trigger is configured to cause a retraining of the one or more machine learning models.
Clause 9. The method of clause 1 wherein the object track list includes shape information to represent a detected object.
Clause 10. The method of clause 1 wherein the object track list includes at least a location and a velocity of a detected object.
Clause 11. The method of clause 1 further comprising receiving map information, wherein generating the dynamic grid is based at least in part on the map information.
Clause 12. The method of clause 1 further comprising receiving remote sensor information via a CV2X network communication, wherein generating the dynamic grid is based at least in part on the remote sensor information.
Clause 13. The method of clause 12 wherein the remote sensor information is provided by a roadside unit (RSU).
Clause 14. An apparatus, comprising: at least one memory; one or more sensors; at least one processor communicatively coupled to the at least one memory and the one or more sensors, and configured to: obtain sensor information from the one or more sensors; determine a first set of object data based at least in part on the sensor information and an object recognition process; generate a dynamic grid based at least in part on the sensor information; determine a second set of object data based at least in part on the dynamic grid; and output an object track list based on a fusion of the first set of object data and the second set of object data.
Clause 15. The apparatus of clause 14 wherein the one or more sensors include at least a camera and a radar sensor.
Clause 16. The apparatus of clause 14 wherein the at least one processor is further configured to identify clusters of dynamic grid cells in the dynamic grid.
Clause 17. The apparatus of clause 16 wherein the clusters of dynamic grid cells have similar velocities.
Clause 18. The apparatus of clause 16 wherein the clusters of dynamic grid cells have similar object classifications.
Clause 19. The apparatus of clause 14 wherein the at least one processor is further configured to generate an occlusion grid comprising occluded grid cells, and determine the second set of object data based at least in part on the occlusion grid.
Clause 20. The apparatus of clause 14 wherein the at least one memory includes one or more machine learning models and the at least one processor is further configured to output indications of identified objects based at least in part on the sensor information and the one or more machine learning models.
Clause 21. The apparatus of clause 20 wherein the at least one processor is further configured to output an Active Learning (AL) trigger based at least in part on a comparison of the first set of object data and the second set of object data, and to retrain the one or more machine learning models in response to the AL trigger.
Clause 22. The apparatus of clause 14 wherein the object track list includes shape information to represent a detected object.
Clause 23. The apparatus of clause 14 wherein the object track list includes at least a location and a velocity of a detected object.
Clause 24. The apparatus of clause 14 wherein the at least one processor is further configured to receive map information and generate the dynamic grid based at least in part on the map information.
Clause 25. The apparatus of clause 14 wherein the at least one processor is further configured to receive remote sensor information via a CV2X network communication and generate the dynamic grid based at least in part on the remote sensor information.
Clause 26. The apparatus of clause 25 wherein the remote sensor information is provided by a roadside unit (RSU).
Clause 27. An apparatus for generating an object track list in a vehicle, comprising: means for obtaining sensor information from one or more sensors on the vehicle; means for determining a first set of object data based at least in part on the sensor information and an object recognition process; means for generating a dynamic grid based on an environment proximate to the vehicle based at least in part on the sensor information; means for determining a second set of object data based at least in part on the dynamic grid; and means for outputting the object track list based on a fusion of the first set of object data and the second set of object data.
Clause 28. A non-transitory processor-readable storage medium comprising processor-readable instructions configured to cause one or more processors to generate an object track list in a vehicle, comprising code for: obtaining sensor information from one or more sensors on the vehicle; determining a first set of object data based at least in part on the sensor information and an object recognition process; generating a dynamic grid based on an environment proximate to the vehicle based at least in part on the sensor information; determining a second set of object data based at least in part on the dynamic grid; and outputting the object track list based on a fusion of the first set of object data and the second set of object data.

1. A method for generating an object track list in a vehicle, comprising:
obtaining sensor information from one or more sensors on the vehicle;
determining a first set of object data based at least in part on the sensor information and an object recognition process;
generating a dynamic grid based on an environment proximate to the vehicle based at least in part on the sensor information;
determining a second set of object data based at least in part on the dynamic grid; and
outputting the object track list based on a fusion of the first set of object data and the second set of object data.

2. The method of claim 1 wherein the one or more sensors include at least a camera and a radar sensor.

3. The method of claim 1 wherein determining the second set of object data includes identifying clusters of dynamic grid cells in the dynamic grid.

4. The method of claim 3 wherein the clusters of dynamic grid cells have similar velocities.

5. The method of claim 3 wherein the clusters of dynamic grid cells have similar object classifications.

6. The method of claim 1 further comprising generating an occlusion grid comprising occluded grid cells, wherein determining the second set of object data is based at least in part on the occlusion grid.

7. An apparatus, comprising:
at least one memory;
one or more sensors;
at least one processor communicatively coupled to the at least one memory and the one or more sensors, and configured to:
obtain sensor information from the one or more sensors;
determine a first set of object data based at least in part on the sensor information and an object recognition process;
generate a dynamic grid based at least in part on the sensor information;
determine a second set of object data based at least in part on the dynamic grid; and
output an object track list based on a fusion of the first set of object data and the second set of object data.

8. The apparatus of claim 7 wherein the one or more sensors include at least a camera and a radar sensor.

9. The apparatus of claim 7 wherein the at least one processor is further configured to identify clusters of dynamic grid cells in the dynamic grid.

10. The apparatus of claim 9 wherein the clusters of dynamic grid cells have similar velocities.

11. The apparatus of claim 9 wherein the clusters of dynamic grid cells have similar object classifications.

12. The apparatus of claim 7 wherein the at least one processor is further configured to generate an occlusion grid comprising occluded grid cells, and determine the second set of object data based at least in part on the occlusion grid.

13. The apparatus of claim 7 wherein the at least one memory includes one or more machine learning models and the at least one processor is further configured to output indications of identified objects based at least in part on the sensor information and the one or more machine learning models.

14. The apparatus of claim 13 wherein the at least one processor is further configured to output an Active Learning (AL) trigger based at least in part on a comparison of the first set of object data and the second set of object data, and to retrain the one or more machine learning models in response to the AL trigger.

15. The apparatus of claim 7 wherein the object track list includes shape information to represent a detected object.

16. The apparatus of claim 7 wherein the object track list includes at least a location and a velocity of a detected object.

17. The apparatus of claim 7 wherein the at least one processor is further configured to receive map information and generate the dynamic grid based at least in part on the map information.

18. The apparatus of claim 7 wherein the at least one processor is further configured to receive remote sensor information via a CV2X network communication and generate the dynamic grid based at least in part on the remote sensor information.

19. The apparatus of claim 18 wherein the remote sensor information is provided by a roadside unit (RSU).

20. An apparatus for generating an object track list in a vehicle, comprising:
means for obtaining sensor information from one or more sensors on the vehicle;
means for determining a first set of object data based at least in part on the sensor information and an object recognition process;
means for generating a dynamic grid based on an environment proximate to the vehicle based at least in part on the sensor information;
means for determining a second set of object data based at least in part on the dynamic grid; and
means for outputting the object track list based on a fusion of the first set of object data and the second set of object data.
